(19) United States
(12) Patent Application Publication
(10) Pub. No.: US 2017/0298726 A1
(43) Pub. Date: Oct. 19, 2017

(54) Analyzing Drill Cuttings Using Ultraviolet Oil Fluorescence

(71) Applicant: Halliburton Energy Services, Inc., Houston, TX (US)

(72) Inventors: Adrian E. Smith, Rochdale (GB); Matt Henderson, Inverbervie (GB); Paul Brown, Milltimber (GB)

(21) Appl. No.: 15/512,936

(22) PCT Filed: Nov. 24, 2014
(86) PCT No.: PCT/US2014/067144

§ 371 Date: Mar. 21, 2017

(51) Int. Cl. E21B 49/00; G01V 8/10; G01N 21/64; E21B 21/06

(52) U.S. Cl. CPC E21B 49/005; G01N 21/6456; G01V 8/10; G01N 2201/061; E21B 21/065; G01N 2201/12; G01N 2201/062

(57) ABSTRACT

An analysis tool that use ultraviolet wavelengths of oil fluorescence to analyze drill cuttings. An oil fluorescence tool includes an ultraviolet light source which directs ultraviolet light toward drilled cuttings. The interaction of the light and cuttings results in fluorescence emanating from the oil. These wavelengths are recognized by a camera which generates an image showing the intensity of the fluorescence. A computer having image recognition software is coupled to the camera in order to interpret and display the intensity and range of the fluorescence in the image.

### FIELD OF THE DISCLOSURE

The present disclosure generally relates to the evaluation of hydrocarbon content in an underground formation and, more particularly, to a method and tool that uses ultraviolet wavelengths of oil fluorescence in analyzing drill cuttings.

### BACKGROUND

Fluorescence has been used for decades as a technique for detecting oil in drill cuttings. For much of that time, the method used to determine the presence of oil in drill cuttings was crude, wherein an operator exposed the cuttings sample to a broad spectrum ultraviolet light in order to see fluorescence which indicated the presence of oil. To date, however, most fluorescence techniques have focused on the visible spectrum where oil fluorescence is weak, or applied complex spectrometry to analyze the presence of oil.

Therefore, there is a need in the art to provide alternative, reliable and more cost-effective oil fluorescence analysis technique.

### BRIEF DESCRIPTION OF THE DRAWINGS

FIG. 1 illustrates an oil fluorescence tool according to certain illustrative embodiments of the present disclosure;

FIG. 2 is a graph which plots the fluorescence spectra for an oil sample which was excited by an ultraviolet light source of 220 nm;

FIG. 3 illustrates an oil fluorescence tool according to certain alternative illustrative embodiments of the present disclosure; and

FIG. 4 shows a well system useful to illustrate one downhole application in which the present disclosure may be utilized.

### DESCRIPTION OF ILLUSTRATIVE EMBODIMENTS

Illustrative embodiments and related methods of the present disclosure are described below as they might be employed in a tool and method which uses ultraviolet wavelengths of oil fluorescence in analyzing drill cuttings. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the disclosure will become apparent from consideration of the following description and drawings.

As described herein, embodiments of the present disclosure are directed to tools and related methods using ultraviolet wavelengths of oil fluorescence, those invisible to the human eye, in analyzing drill cuttings. In a generalized embodiment, an oil fluorescence tool includes an ultraviolet light source which directs light of certain wavelengths toward a sample of drilled cuttings. The interaction of the ultraviolet light and the drill cuttings results in fluorescence emanating from the oil, or traces of oil, at crude oil's natural wavelengths. These wavelengths (i.e., oil fluorescence) will be recognized by a camera adapted to respond to those ultraviolet wavelengths below the range of human vision where the main fluorescence occurs, and to generate an image showing the intensity of the fluorescence. A computer (i.e., processing circuitry) having image recognition software is coupled to the camera in order to interpret and display the intensity and range of the fluorescence in the image.

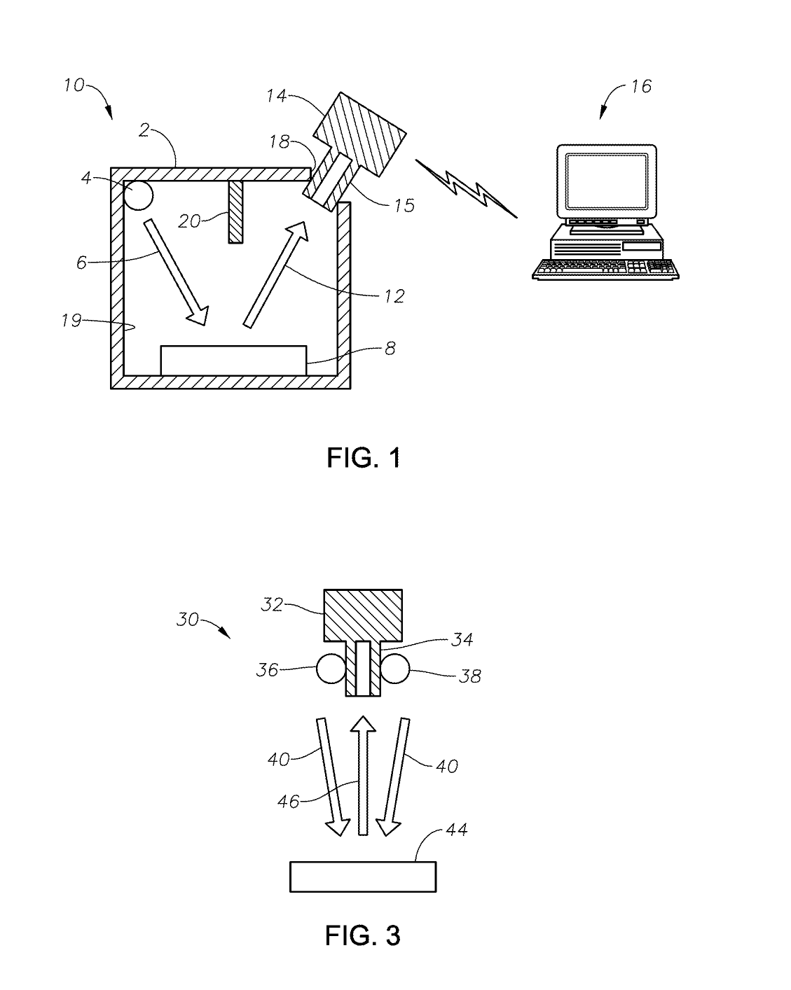

FIG. 1 illustrates an oil fluorescence tool according to certain illustrative embodiments of the present disclosure. Oil fluorescence tool 10 includes an enclosure 2 that houses, among others, an ultraviolet light source 4 which directs ultraviolet excitation 6 (i.e., light) toward a sample of drilled cuttings 8. Ultraviolet light source 4 may be, for example, a flurorescent tube with sufficient filtering or a light emitting diode tuned to an appropriate wavelength which is invisible to the human eye. Since most crude oils start to fluoresce at wave lengths of about 270 nm, the source must be of a shorter wavelength that that and is usually selected at about 245 nm. In addition, deep ultraviolet light emitting diodes may be utilized in certain embodiments and used with, for example, a number of wavelengths starting at 240 nm.

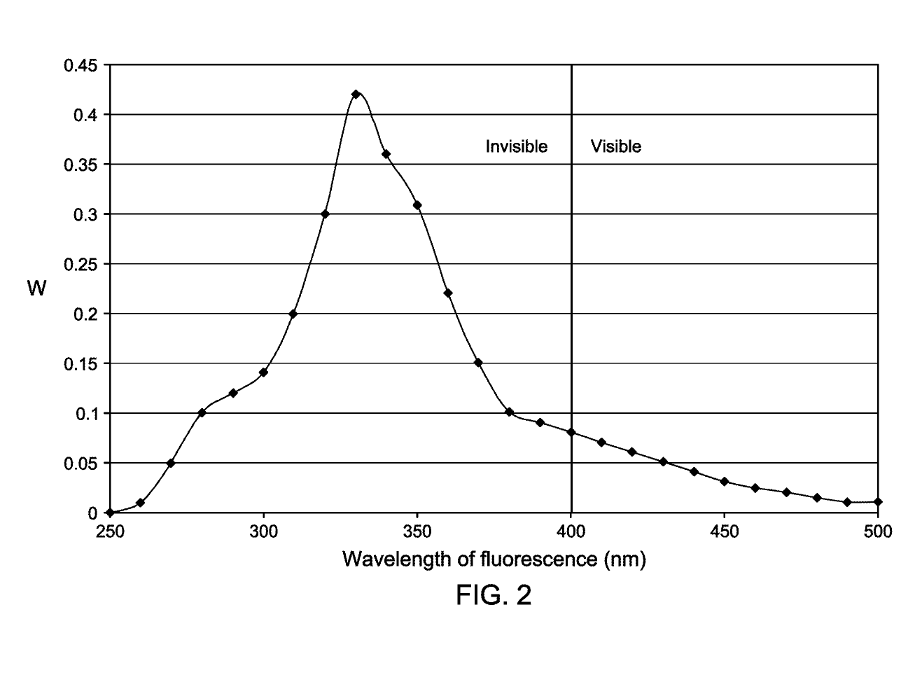

FIG. 2 is a graph which plots the fluorescence spectra for a sample oil which was excited by an ultraviolet light source of 220 nm. The y-axis shows the function w, which represents the fluorescence spectra, and the x-axis shows the wavelengths in nanometers. The boundary between the visible and invisible wavelength is approximately 400 nm. As can be seen, it is within the ultraviolet wavelengths where fluorescence is strongest. Specifically, the natural fluorescence of crude oil, for example, is centered around 365 nm. Therefore, the embodiments describe herein specifically target the invisible spectrum because oil fluoresces more at lower wavelengths.

Referring back to FIG. 1, after ultraviolet excitation 6 interacts with drill cuttings 8, fluorescence 12 is produced and reflects back toward a cameral 14. In this embodiment, camera 14 may be, for example, a charged coupled device chip, also referred to as a CCD, which is sensitive to ultraviolet wavelength light. Note that conventional charged coupled devices typically have ultraviolet filters so that they only pass visible light. In the embodiments of the present disclosure, however, when a charged coupled device is used, the device would not have such a protective ultraviolet filter. As a result, camera 14 is highly sensitive to the intensity of fluorescence 12 and will generate an image reflecting that intensity. In an alternative embodiment, camera 14 may be a complementary metal-oxide semiconductor device, also known as a CMOS, which is sensitive to ultraviolet wavelength light. Additionally, camera 14 has a lens, tube and/or other optics 15 necessary to focus fluorescence 12 onto the specific image capturing device used. In this embodiment, enclosure 2 has a camera port 18 in which camera 14 is positioned or extends into. In alternate embodiments, however, camera 14 may be completely positioned inside enclosure 2.

In certain illustrative embodiments, a computer processing unit 16 is communicably coupled (wired or wireless) to oil fluorescence tool 10 in order to analyze the image data sent from camera 14. Computer processing unit 16 may include at least one processor, a non-transitory, computer-readable storage, transceiver/network communication module, optional I/O devices, and an optional display (e.g., user interface). Computer processing unit 16 may have stored thereon image recognition software which allows it to display the intensity and/or intensity ranges of the fluorescence in the image. One example of such image recognition software is Image-Pro® Plus.

In yet other embodiments, computer processing unit 16 scans and quantifies the image data. Here, for example, computer processing unit 16 would scan the image to determine the amount of fluorescence in each part of the scanned image. As a result, computer processing unit 16 would generate a number to represent the intensity of the amount of fluorescence that was observed. In this embodiment, the software platform utilized may be, for example, the Image-Pro® Plus platform with the corresponding Software Development Kit.

Although not explicitly shown in FIG. 1, it will be recognized that computer processing unit 16 may be connected to one or more public and/or private networks via one or more appropriate network connections. Moreover, those ordinarily skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof in a computer system or other processing system.

As previously described, the illustrative embodiment of oil fluorescence tool 10 shown in FIG. 1 includes an enclosure 2 that houses ultraviolet light source 4, drill cuttings 8 and camera 14. Enclosure 2 also includes a partition 20 which extends from an inner surface 19 of enclosure 2 between ultraviolet light source 4 and camera port 18. Partition 20 acts to prevent ultraviolet light 6 from propagating directly into camera 14, thus producing incorrect image data. Furthermore, inner surface 19 is colored black, or some other dark color, to prevent light reflections inside enclosure 2.

FIG. 3 illustrates another oil fluorescence tool according to certain illustrative embodiments of the present disclosure. Unlike oil fluorescence tool 10, oil fluorescence tool 30 does not include an enclosure. Rather, oil fluorescence tool 30 includes a camera 32 similar to the camera described above. Camera 32 includes a lens or optics 34 extending therefrom used to focus fluorescence onto the image capturing device being utilized. In this embodiment, oil fluorescence tool 30 includes a first and second ultraviolet light source 36,38 positioned on opposite sides of lens 34. During operation, ultraviolet light sources 36,38 emit ultraviolet light 40 toward drill cuttings 44, whereby oil fluorescence 46 is produced. In this embodiment, ultraviolet light 40 may be a sustained beam or may be flashes of light. Nevertheless, the produced fluorescence 46 is eventually focused by lens 34 and captured by the image capturing device of camera 32. Although not shown, oil fluorescence tool 30 is also connected to processing circuitry whereby an intensity image of the fluorescence may be displayed as previously described.

The illustrative oil fluorescence tools described herein may be utilized to acquire real-time or historical images of drill cuttings. When real-time images are desired, oil fluorescence tool 10 may be preferred because it is essentially a black box. Enclosure 2 will protect the components during movement and, during use, enclosure 2 protects drill cuttings 8 from the visible light. The drill cuttings may be inserted into the tool in any number of ways, including, for example, by hand or some automated means. Although not shown, the tool would have some form of door or opening in which to insert the drilled cuttings.

When historical images are preferred, oil fluorescence tool 30 may be utilized along with an ultraviolet source which produces a short flash of excitation (CMOS chip, for example). The excitation flash must be strong enough to overcome interference by the surrounding ambient light. In this embodiment, memory circuitry on-board the tool (or remote therefrom) may be utilized to capture the images for subsequent analysis.

The illustrative oil fluorescence tools described herein may be used in a variety of applications. For example, the oil fluorescence tools may be positioned at the surface along a return line of a wellbore system. Alternatively, the oil fluorescence tools may be used in a laboratory environment. Essentially, the oil fluorescence tools described herein may be used in any similar environment in which the drill cuttings have been separated from the downhole fluid or mud. Such a separation system may be automated or manual.

Moreover, in certain embodiments, instead of a sample of raw cuttings from the return line, individual cuttings may be analyzed separately. The illustrative oil fluorescence tools described herein would be used to acquire an image of the non-visible wavelengths in the same way as the general cuttings. It would also be used if the cuttings were immersed in a solvent and the relative movement of the oil was imaged by its fluorescence as it moved into the solvent. Equally, if a filter paper was used to show the chromatographic movement of the oil by its fluorescence, the non-visible wavelengths would also be captured by the tools described herein.

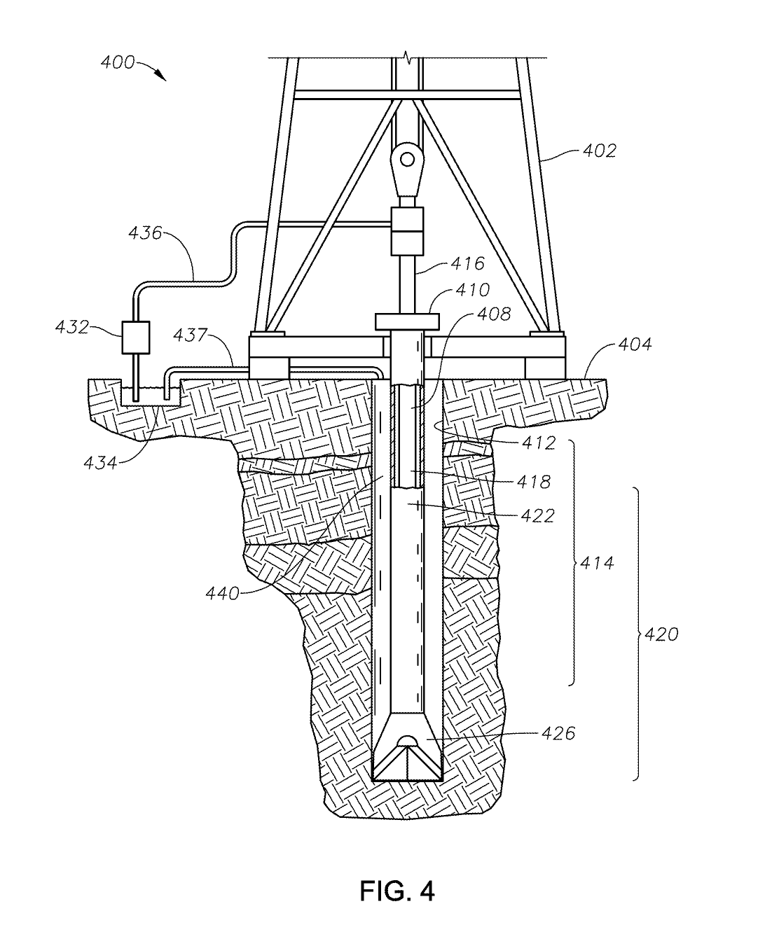

FIG. 4 shows a well system 400 to illustrate an illustrative application for embodiments of the present disclosure. It should be noted that the system 400 can also include a system for pumping or other operations. System 400 includes a drilling rig 402 located at a surface 404 of a wellbore. Drilling rig 402 provides support for a down hole apparatus, including a drill string 408. Drill string 408 penetrates a rotary table 410 for drilling a borehole/wellbore 412 through subsurface formations 414. Drill string 408 includes a Kelly 416 (in the upper portion), a drill pipe 418 and a bottom hole assembly 420 (located at the lower portion of drill pipe 418). In certain illustrative embodiments, bottom hole assembly 420 may include drill collars 422, a downhole tool 424 and a drill bit 426. Downhole tool 424 may be any of a number of different types of tools including measurement-while-drilling (“MWD”) tools, logging-while-drilling (“LWD”) tools, etc.

During drilling operations, drill string 408 (including Kelly 416, drill pipe 418 and bottom hole assembly 420) may be rotated by rotary table 410. In addition or alternative to such rotation, bottom hole assembly 420 may also be rotated by a motor that is downhole. Drill collars 422 may be used to add weight to drill bit 426. Drill collars 422 also optionally stiffen bottom hole assembly 420 allowing it to transfer the weight to drill bit 426. The weight provided by drill collars 422 also assists drill bit 426 in the penetration of surface 404 and subsurface formations 414, whereby drill cuttings are produced.

During drilling operations, a mud pump 432 optionally pumps drilling fluid (e.g., drilling mud), from a mud pit 434 through a hose 436, into drill pipe 418, and down to drill bit 426. The drilling fluid can flow out from drill bit 426 and return back to the surface (carrying drill cuttings also) through an annular area 440 between drill pipe 418 and the sides of borehole 412. The drilling fluid and drill cuttings may then be returned to the mud pit 434, for example via pipe 437, and the fluid is filtered. Here, for example, the drill cuttings may be removed from the mud and analyzed using the oil fluorescence tools described herein. The drilling fluid also cools drill bit 426, as well as provides for lubrication of drill bit 426 during the drilling operation. Additionally, as previously stated, the drilling fluid removes the drill cuttings of subsurface formations 414 created by drill bit 426.

Accordingly, embodiments of the oil fluorescence tools described herein provide a number of advantages. Instead of the complex spectroscopic equipment used in conventional fluorescence techniques, the oil fluorescence tools described herein utilize a more cost effective and reliable method of analysis. Moreover, conventional fluorescence techniques focus only on the visible spectrum where the data is poor. The oil fluorescence tools described herein focus only on the invisible wavelengths where the maximum amount of fluorescence data is found.

Embodiments and methods described herein further relate to any one or more of the following paragraphs:

1. An oil fluorescence tool for analyzing drill cuttings, comprising an ultraviolet light source which directs light to one or more drill cuttings, thereby producing oil fluorescence; and a camera positioned to receive the oil fluorescence and produce a corresponding image showing an intensity of the oil fluorescence.

2. An oil fluorescence tool as defined in paragraph 1, wherein the camera comprises a charge coupled device; or a complementary metal-oxide semiconductor device.

3. An oil fluorescence tool as defined in paragraphs 1 or 2, wherein the charged coupled device does not include an ultra violet filter.

4. An oil fluorescence tool as defined in any of paragraphs 1-3, further comprising an enclosure to house the ultraviolet light source and drill cuttings to protect each from visible light.

5. An oil fluorescence tool as defined in any of paragraphs 1-4, further comprising a camera port positioned along the enclosure to house the camera.

6. An oil fluorescence tool as defined in any of paragraphs 1-5, further comprising a partition extending from an inner surface of the enclosure, the partition being positioned between the ultraviolet light source and the camera port.

7. An oil fluorescence tool as defined in any of paragraphs 1-6, wherein the inner surface of the enclosure is black.

8. An oil fluorescence tool as defined in any of paragraphs 1-7, wherein the camera comprises a lens extending therefrom; a second ultraviolet light source forms part of the oil fluorescence tool; and the ultraviolet light source and the second ultraviolet light source are positioned on opposite sides of the lens to direct a light flash toward the drill cuttings, wherein the oil fluorescence is reflected back up toward the lens.

9. An oil fluorescence tool as defined in any of paragraphs 1-8, wherein the oil fluorescence tool is coupled to a return line of a wellbore.

10. An oil fluorescence method for analyzing drill cuttings, the method comprising emitting ultraviolet light toward one or more drill cuttings, thereby producing oil fluorescence; receiving the oil fluorescence by a camera; and generating an image which reflects an intensity of the oil fluorescence.

11. An oil fluorescence method as defined in paragraph 10, wherein the ultraviolet light is emitted by a charge coupled device or a complementary metal-oxide semiconductor device.

12. An oil fluorescence method as defined in paragraphs 10 or 11, wherein the ultraviolet light is emitted inside an enclosure that houses the ultraviolet light source and drill cuttings.

13. An oil fluorescence method as defined in any of paragraphs 10-12, wherein the oil fluorescence is received by the camera through a port positioned along the enclosure.

14. An oil fluorescence method as defined in any of paragraphs 10-13, further comprising preventing the ultraviolet light from propagating directly into the camera using a partition positioned between the ultraviolet light source and the camera port.

15. An oil fluorescence method as defined in any of paragraphs 10-14, wherein the camera comprises a lens extending therefrom; a second ultraviolet light source forms part of the oil fluorescence tool; and the ultraviolet light is emitted as flashes toward the drilling cuttings using the ultraviolet light source and the second ultraviolet light source positioned on opposite sides of the lens.

16. An oil fluorescence method as defined in any of paragraphs 10-15, wherein the drill cuttings are received from a return line of a wellbore.

Although various embodiments and methodologies have been shown and described, the disclosure is not limited to such embodiments and methodologies and will be understood to include all modifications and variations as would be apparent to one skilled in the art. Therefore, it should be understood that embodiments of the disclosure are not intended to be limited to the particular forms disclosed. Rather, the intention is to cover all modifications, equivalents and alternatives falling within the spirit and scope of the disclosure as defined by the appended claims.

What is claimed is:

1. An oil fluorescence tool for analyzing drill cuttings, comprising:
an ultraviolet light source which directs light to one or more drill cuttings, thereby producing oil fluorescence; and
a camera positioned to receive the oil fluorescence and produce a corresponding image showing an intensity of the oil fluorescence.

2. An oil fluorescence tool as defined in claim 1, wherein the camera comprises:
a charge coupled device; or
a complementary metal-oxide semiconductor device.

3. An oil fluorescence tool as defined in claim 2, wherein the charged coupled device does not include an ultra violet filter.

4. An oil fluorescence tool as defined in claim 1, further comprising an enclosure to house the ultraviolet light source and drill cuttings to protect each from visible light.

5. An oil fluorescence tool as defined in claim 4, further comprising a camera port positioned along the enclosure to house the camera.

6. An oil fluorescence tool as defined in claim 5, further comprising a partition extending from an inner surface of the enclosure, the partition being positioned between the ultraviolet light source and the camera port.

7. An oil fluorescence tool as defined in claim 6, wherein the inner surface of the enclosure is black.

8. An oil fluorescence tool as defined in claim 1, wherein:
the camera comprises a lens extending therefrom;
a second ultraviolet light source forms part of the oil fluorescence tool; and
the ultraviolet light source and the second ultraviolet light source are positioned on opposite sides of the lens to direct a light flash toward the drill cuttings,
wherein the oil fluorescence is reflected back up toward the lens.

9. An oil fluorescence tool as defined in claim 1, wherein the oil fluorescence tool is coupled to a return line of a wellbore.

10. An oil fluorescence method for analyzing drill cuttings, the method comprising:
emitting ultraviolet light toward one or more drill cuttings, thereby producing oil fluorescence;
receiving the oil fluorescence by a camera; and
generating an image which reflects an intensity of the oil fluorescence.

11. An oil fluorescence method as defined in claim 10, wherein the ultraviolet light is emitted by a charge coupled device or a complementary metal-oxide semiconductor device.

12. An oil fluorescence method as defined in claim 10, wherein the ultraviolet light is emitted inside an enclosure that houses the ultraviolet light source and drill cuttings.

13. An oil fluorescence method as defined in claim 12, wherein the oil fluorescence is received by the camera through a port positioned along the enclosure.

14. An oil fluorescence method as defined in claim 13, further comprising preventing the ultraviolet light from propagating directly into the camera using a partition positioned between the ultraviolet light source and the camera port.

15. An oil fluorescence method as defined in claim 10, wherein:
the camera comprises a lens extending therefrom;
a second ultraviolet light source forms part of the oil fluorescence tool; and
the ultraviolet light is emitted as flashes toward the drilling cuttings using the ultraviolet light source and the second ultraviolet light source positioned on opposite sides of the lens.

16. An oil fluorescence method as defined in claim 10, wherein the drill cuttings are received from a return line of a wellbore.
